(19) United States
(12) Patent Application Publication
(10) Pub. No.: US 2026/0309194 A1
(43) Pub. Date: Oct. 8, 2026

(54) ONE-WAY CLUTCH

(71) Applicant: NSK-Warner K.K., Tokyo (JP)

(72) Inventors: Yoshiya OZAWA, Shizuoka (JP); Tomoyuki Kirino, Shizuoka (JP); Nariaki Tamura, Shizuoka (JP); Masato Kobayashi, Shizuoka (JP)

(73) Assignee: NSK-Warner K.K., Tokyo (JP)

(21) Appl. No.: 19/551,845

(22) Filed: Feb. 27, 2026

(30) Foreign Application Priority Data
Apr. 2, 2025 (JP) 2025-060980

(51) Int. Cl. F16D 41/07; F16D 41/06

(52) U.S. Cl. CPC F16D 41/07; F16D 2041/0605

(57) ABSTRACT

A one-way clutch includes cams, a retainer, and a spring. The cam includes an outer surface facing an outer ring, and a groove portion. The retainer includes a retainer body. The retainer body includes a first side plate and protrusions protruding from the first side plate. The protrusions include column portions and at least one spring protrusion. A window portion with the cam arranged is formed between two column portions adjacent to each other. One side in the axial direction of the window portion is closed by the first side plate, and the other side is open. A hook portion protruding outward in the radial direction and arranged on the other side in the axial direction relative to the spring is formed on the spring protrusion. The first side plate is provided with a cutaway formed by cutting away a portion facing the hook portion in the axial direction.

### CROSS-REFERENCE TO RELATED APPLICATION

The present application claims priority to and incorporates by reference the entire contents of Japanese Patent Application No. 2025-060980 filed in Japan on Apr. 2, 2025.

### BACKGROUND

### 1. Technical Field

What is disclosed herein relates to a one-way clutch.

### 2. Description of the Related Art

A one-way clutch is arranged between an outer ring and an inner ring arranged coaxially. When the outer ring rotates in one direction, the one-way clutch transmits torque of the outer ring to the inner ring. On the other hand, when the outer ring rotates in the other direction, the one-way clutch does not transmit the torque of the outer ring to the inner ring, and the outer ring is idle. There are various types of one-way clutches. A one-way clutch in Japanese Patent Application Laid-open No. 2024-041462 includes a plurality of cams arrayed in a circumferential direction, a retainer that holds the cams, and an annular spring provided across an outer peripheral side of the cams. The one-way clutch having such a configuration may be referred to as a cam clutch.

The retainer in Japanese Patent Application Laid-open No. 2024-041462 includes a pair of side plates and a plurality of column portions. The side plates are formed in an annular shape and are arranged in a manner of being separated from each other in an axial direction. The column portions extend in the axial direction between the side plates and are arrayed apart from each other in the circumferential direction. Thus, a quadrangular frame member is formed by the two column portions adjacent to each other in the circumferential direction and the pair of side plates. An inner portion of the frame member forms a window portion, and the cams are arranged on a radially outer side of the window portion.

The retainer may be manufactured by resin injection molding. In a case where the retainer is manufactured by resin injection molding, a die that moves in a radial direction and forms a periphery of a window portion is required in addition to a die that moves in an axial direction. Thus, the dies are complicated, and a retainer capable of simplifying the die is desired.

In assembly of a one-way clutch, cams are arranged and fixed one by one to the window portions from the radially outer side. Then, a spring is provided across the outer peripheral side of the cams. In such a manner, it is necessary to arrange and fix the cams one by one in the window portions, and a decrease in productivity is caused.

For the foregoing reasons, there is a need for a one-way clutch capable of simplifying dies and improving productivity.

### SUMMARY

According to an aspect, a one-way clutch includes a plurality of cams arranged between an outer ring and an inner ring and arrayed in a circumferential direction, a retainer that holds the cams, and an annular spring provided across an outer peripheral side of the cams. Each of the cams includes an outer surface facing an outer side in a radial direction and facing the outer ring, and a groove portion in which the outer surface is cut away in the circumferential direction and the spring is housed. An axial direction is defined as a direction parallel to a central axis of the outer ring. The retainer includes a retainer body made of resin. The retainer body includes an annular first side plate arranged on one side in the axial direction with respect to the cams, and a plurality of protrusions protruding from the first side plate to the other side in the axial direction and arrayed in the circumferential direction. The protrusions include a plurality of column portions, and at least one spring protrusion with the spring provided across the outer peripheral side. A window portion with the cam arranged is formed between two of the column portions adjacent to each other in the circumferential direction. One side in the axial direction of the window portion is closed by the first side plate, and the other side in the axial direction thereof is open. A hook portion protruding outward in the radial direction and arranged on the other side in the axial direction with respect to the spring is formed on the at least one spring protrusion. The first side plate is provided with a cutaway formed by cutting away a portion facing the hook portion in the axial direction.

### BRIEF DESCRIPTION OF THE DRAWINGS

FIG. 1 is a view of a one-way clutch of a first embodiment as viewed in an axial direction;

FIG. 2 is a view viewed in a direction of an arrow II in FIG. 1;

FIG. 3 is a view of a roller of the first embodiment as viewed from an outer peripheral side;

FIG. 4 is a view of a cam of the first embodiment as viewed from a second direction;

FIG. 5 is a view of the cam when an outer ring rotates in a second rotation direction as viewed from the second direction;

FIG. 6 is a view of the cam when the outer ring rotates in a first rotation direction as viewed from the second direction;

FIG. 7 is a view of a retainer body of the first embodiment as viewed from the second direction;

FIG. 8 is an enlarged view as viewed in a direction of an arrow VIII in FIG. 7;

FIG. 9 is a sectional view taken along a line of an arrow IX-IX in FIG. 8;

FIG. 10 is an enlarged view as viewed in a direction of an arrow X in FIG. 7;

FIG. 11 is a view illustrating an assembly process of the one-way clutch of the first embodiment;

FIG. 12 is a view of a retainer (retainer body) of a first modification as viewed from the second direction;

FIG. 13 is a sectional view taken along a line XIII-XIII in FIG. 12;

FIG. 14 is a view as viewed in a direction of an arrow XIV in FIG. 12;

FIG. 15 is a view of a retainer body of a second modification as viewed from the second direction;

FIG. 16 is a sectional view taken along a line XVI-XVI in FIG. 15;

FIG. 17 is a view as viewed in a direction of an arrow XVII in FIG. 15;

FIG. 18 is a view of a one-way clutch of a third modification as viewed from an outer peripheral side;

FIG. 19 is a view of a state in which a retainer of the third modification is disassembled as viewed from the outer peripheral side;

FIG. 20 is a view of a retainer body of the third modification as viewed from the second direction;

FIG. 21 is a view of a second side plate of the third modification as viewed from a first direction;

FIG. 22 is a view illustrating a method of welding the retainer body and the second side plate in the third modification;

FIG. 23 is a view of a retainer of a fourth modification as viewed from the second direction; and

FIG. 24 is a view of the retainer of the fourth modification as viewed from the outer peripheral side.

### DETAILED DESCRIPTION

A mode for carrying out the present disclosure will be described in detail with reference to the drawings. The present disclosure is not limited by contents described in the following description. Components described below include components that can be easily conceived by those skilled in the art and components that are substantially the same as the conceivable components. Furthermore, the components described below can be appropriately combined.

### First Embodiment

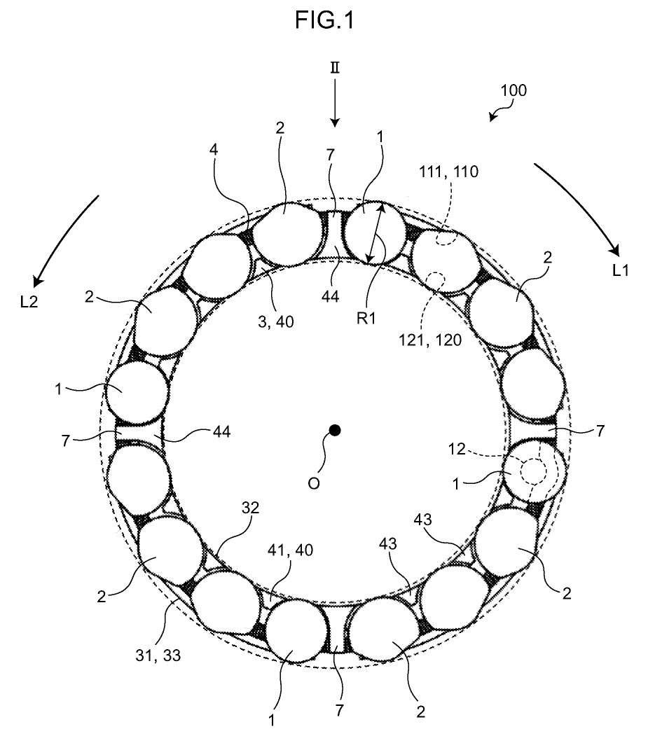

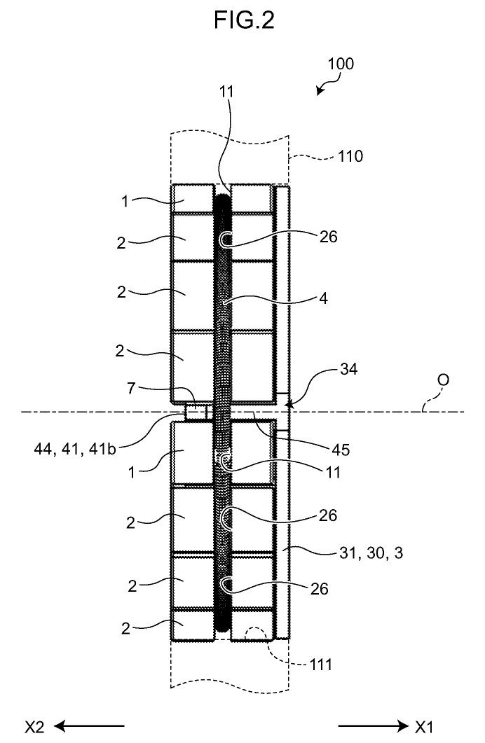

FIG. 1 is a view of a one-way clutch of the first embodiment as viewed in an axial direction. FIG. 2 is a view as viewed in a direction of an arrow II in FIG. 1. First, an outer ring 110 and an inner ring 120 to which a one-way clutch 100 is assembled will be described. As illustrated in FIG. 1, the outer ring 110 is an annular component that rotates about a central axis O. The inner ring 120 is arranged on an inner peripheral side of the outer ring 110 in such a manner as to be coaxial with the outer ring 110. An inner peripheral surface 111 of the outer ring 110 and an outer peripheral surface 121 of the inner ring 120 face each other. A distance between the inner peripheral surface 111 and the outer peripheral surface 121 is R1. Torque is transmitted to the outer ring 110 by a power transmission component (not illustrated), and the outer ring 110 rotates.

In the following description, a direction parallel to the central axis O of the outer ring 110 is referred to as an axial direction. As illustrated in FIG. 2, one side in the axial direction is referred to as a first direction X1, and the other side in the axial direction is referred to as a second direction X2. A direction orthogonal to the central axis O is referred to as a radial direction. With respect to a rotation direction around the central axis O, a case where the one-way clutch 100 is viewed from the second direction X2 is used as a reference as illustrated in FIG. 1. A clockwise direction (rightward rotation direction) as viewed from the second direction X2 is referred to as a first rotation direction L1. A counterclockwise direction (leftward rotation direction) as viewed from the second direction X2 is referred to as a second rotation direction L2.

As illustrated in FIGS. 1 and 2, the one-way clutch 100 of the first embodiment includes a plurality of rollers 1, a plurality of cams 2, a retainer 3, and a spring 4. The one-way clutch 100 is arranged between the outer ring 110 and the inner ring 120.

As illustrated in FIG. 1, the rollers 1 are columnar components. A diameter of the rollers 1 is R1 (see FIG. 1). The rollers 1 abut on the inner peripheral surface 111 of the outer ring 110 and the outer peripheral surface 121 of the inner ring 120. In the present embodiment, the four rollers 1 are provided. The four rollers 1 are arranged at 90° intervals. Thus, a distance between the inner peripheral surface 111 and the outer peripheral surface 121 is R1 at any position in a circumferential direction, and the outer ring 110 and the inner ring 120 are coaxially arranged.

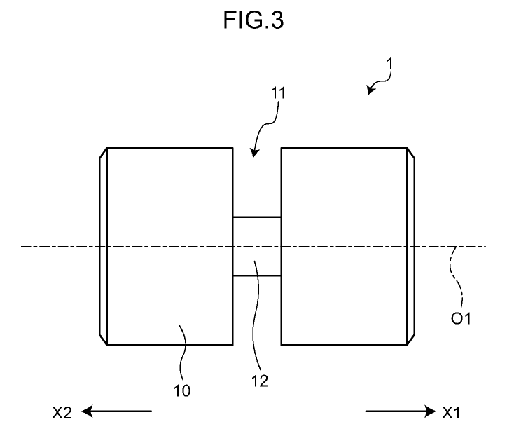

FIG. 3 is a view of the roller of the first embodiment as viewed from an outer peripheral side. As illustrated in FIG. 3, a first groove portion 11 recessed toward a central axis O1 of the roller 1 is formed in a central portion in the axial direction of an outer peripheral surface 10 of the roller 1. The first groove portion 11 is provided around the central axis O1 of the roller 1. That is, the first groove portion 11 has an annular shape. Thus, even when the roller 1 rolls between the outer ring 110 and the inner ring 120, the first groove portion 11 is always open outward in the radial direction. Hereinafter, the central portion in the axial direction of the roller 1 having a small diameter due to the first groove portion 11 is referred to as a small diameter portion 12.

As illustrated in FIG. 2, the spring 4 is housed in the first groove portion 11. As illustrated in FIG. 1, the spring 4 abuts on the small diameter portion 12 from the outer side in the radial direction and biases the roller 1 inward in the radial direction.

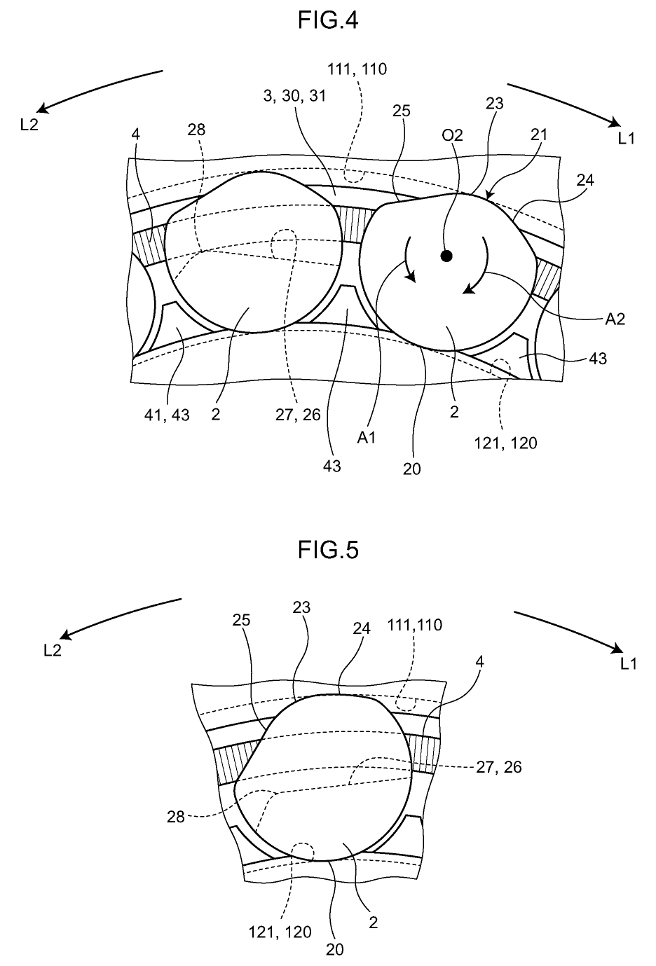

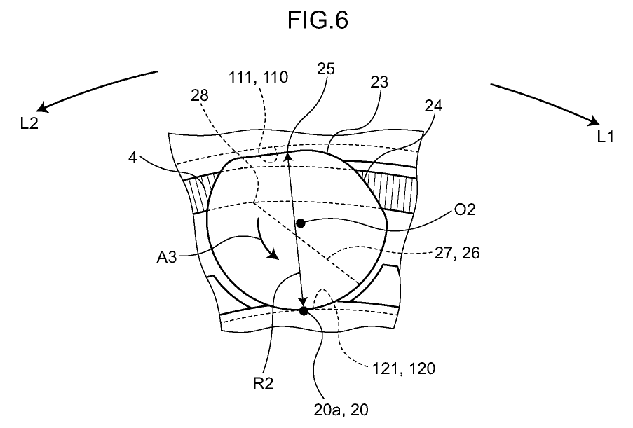

FIG. 4 is a view of the cams of the first embodiment as viewed from the second direction. FIG. 5 is a view of the cam when the outer ring rotates in the second rotation direction as viewed from the second direction. FIG. 6 is a view of the cam when the outer ring rotates in the first rotation direction as viewed from the second direction.

As illustrated in FIG. 1, the three cams 2 are arranged in each position between the rollers 1, and the 12 cams 2 are provided in total. As illustrated in FIG. 4, each of the cams 2 has an arc surface 20 facing inward in the radial direction and an outer surface 21 facing outward in the radial direction. The arc surface 20 is formed in an arc shape about a central axis O2. The outer surface 21 includes an R-shaped top portion 23, a first surface 24 arranged in the first rotation direction L1 from the top portion 23, and a second surface 25 arranged in the second rotation direction L2 from the top portion 23.

In a state in which no torque is transmitted to the outer ring 110, the top portion 23 abuts on the inner peripheral surface 111 of the outer ring 110. When the outer ring 110 rotates in the second rotation direction L2, the top portion 23 is pressed in the second rotation direction L2 by the outer ring 110. As a result, the cam 2 rotates leftward about the central axis O2 (see an arrow A1 in FIG. 4). Then, as illustrated in FIG. 5, the first surface 24 of the cam 2 abuts on the inner peripheral surface 111 of the outer ring 110, and the cam 2 is sandwiched between the outer ring 110 and the inner ring 120. In addition, since all of the cams 2 are sandwiched between the outer ring 110 and the inner ring 120, the inner ring 120 is fixed. As a result, the inner ring 120 rotates together with the outer ring 110 in the second rotation direction L2.

On the other hand, as illustrated in FIG. 4, when the outer ring 110 rotates in the first rotation direction L1 from a state in which the top portion 23 abuts on the inner peripheral surface 111 of the outer ring 110, the top portion 23 is pressed in the first rotation direction L1 by the outer ring 110. Thus, the cams 2 rotate rightward about the central axis O2 (see an arrow A2 in FIG. 4). As a result, as illustrated in FIG. 6, the second surface 25 faces the inner peripheral surface 111 of the outer ring 110. Here, a distance R2 from an abutment position 20a in the arc surface 20 with respect to the inner ring 120 to the second surface 25 is smaller than the distance R1 between the outer ring 110 and the inner ring 120 (see FIG. 1). Thus, the cams 2 are not sandwiched between the outer ring 110 and the inner ring 120, and the outer ring 110 idles.

A second groove portion 26 recessed toward the central axis O2 of the cams 2 is formed in a central portion in the axial direction of the outer surface 21 (see FIG. 2). The second groove portion 26 may be simply referred to as a "groove portion" in the present disclosure. As illustrated in FIG. 4, the second groove portion 26 extends in the circumferential direction. Thus, a bottom surface 27 of the second groove portion 26 also extends in the circumferential direction. The spring 4 is housed in the second groove portion 26.

The bottom surface 27 has a projection portion 28 that protrudes outward in the radial direction. The projection portion 28 is arranged in the second rotation direction L2 with respect to the central axis O2. In a state in which the top portion 23 abuts on the inner peripheral surface 111 of the outer ring 110, the projection portion 28 abuts on the spring 4.

As illustrated in FIG. 5, in a state in which the first surface 24 abuts on the inner peripheral surface 111 of the outer ring 110, the bottom surface 27 (projection portion 28) does not abut on the spring 4. On the other hand, as illustrated in FIG. 6, the projection portion 28 lifts the spring 4 outward in the radial direction in a state in which the second surface 25 faces the inner peripheral surface 111 of the outer ring 110. Thus, the projection portion 28 receives biasing force directed inward in the radial direction from the spring 4. As a result, the cams 2 rotate leftward about the central axis O2 (see an arrow A3). As a result, the cams 2 return to the state in which the top portion 23 abuts on the inner peripheral surface 111 of the outer ring 110 (see FIG. 4).

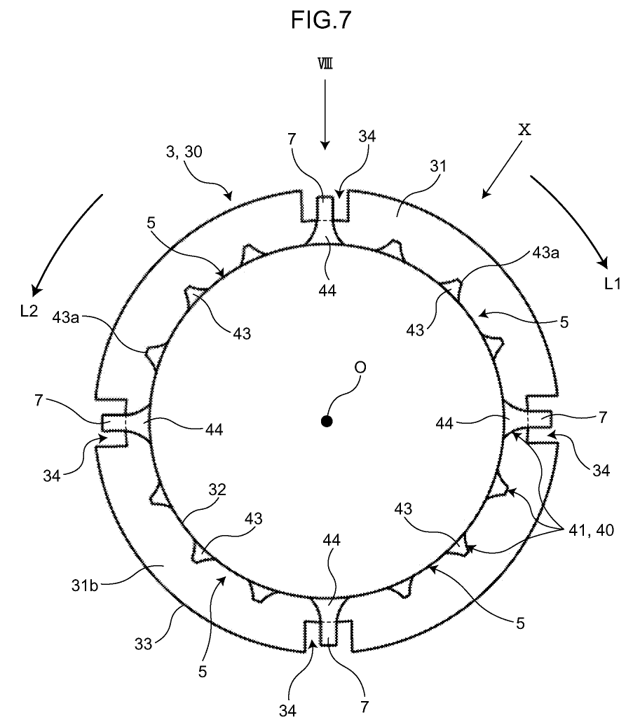

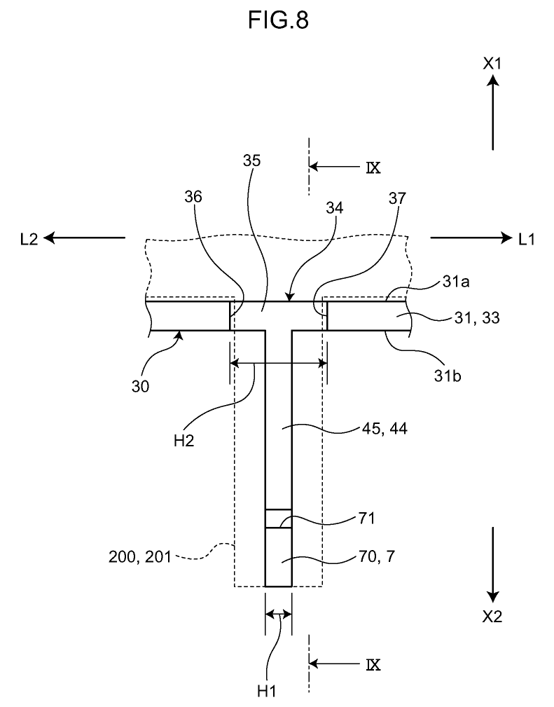

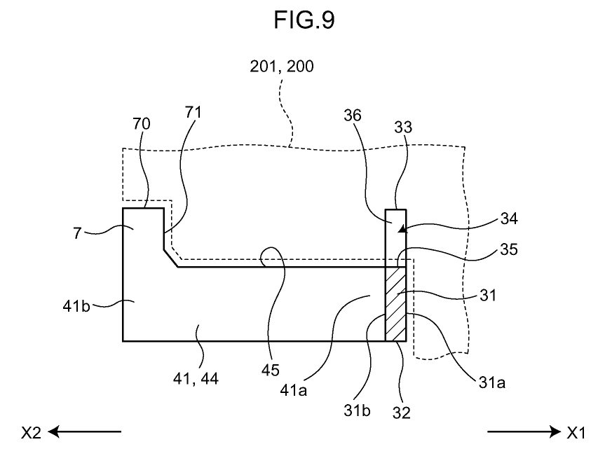

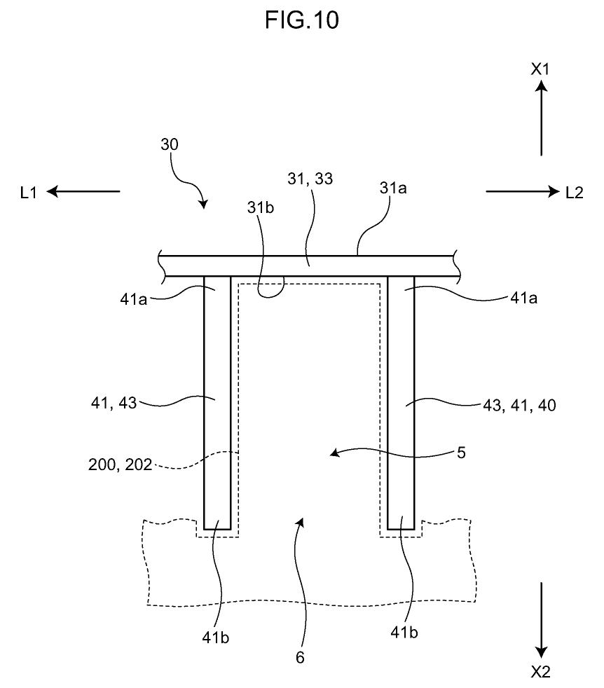

FIG. 7 is a view of the retainer body of the first embodiment as viewed from the second direction. FIG. 8 is an enlarged view as viewed in a direction of an arrow VIII in FIG. 7. FIG. 9 is a sectional view taken along a line of an arrow IX-IX in FIG. 8. FIG. 10 is an enlarged view as viewed in a direction of an arrow X in FIG. 7.

As illustrated in FIG. 7, the retainer 3 of the present embodiment includes only the retainer body 30. The retainer body 30 includes an annular first side plate 31, and a plurality of protrusions 40 protruding in the second direction X2 from the first side plate 31. The retainer body 30 is formed of a resin material, and the first side plate 31 and the protrusions 40 are integrally formed.

The first side plate 31 is arranged in the first direction X1 with respect to the rollers 1 and the cams 2 (see FIG. 2). The first side plate 31 includes a first side surface 31a facing the first direction X1 (not illustrated in FIG. 7. See FIGS. 8 to 10), a second side surface 31b facing the second direction X2, an inner peripheral surface 32 facing inward in the radial direction, and an outer peripheral surface 33 facing outward in the radial direction.

The inner peripheral surface 32 and the outer peripheral surface 33 are circular about the central axis O. A diameter of the inner peripheral surface 32 is larger than a diameter of the outer peripheral surface 121 of the inner ring 120. A diameter of the outer peripheral surface 33 is smaller than that of the inner peripheral surface 111 of the outer ring 110. Thus, the inner peripheral surface 32 is not in contact with the outer peripheral surface 121 of the inner ring 120 (see FIG. 1). In addition, the outer peripheral surface 33 is not in contact with the inner peripheral surface 111 of the outer ring 110 (see FIG. 1).

As illustrated in FIG. 7, the first side plate 31 is provided with cutaways 34 formed by cutting away an edge portion on the outer side in the radial direction of the first side plate 31. The cutaways 34 have a quadrangular shape as viewed in the axial direction. The four cutaways 34 are provided at 90° intervals. As illustrated in FIGS. 8 and 9, an inner surface of each of the cutaways 34 has a bottom surface 35 facing outward in the radial direction, a first side surface 36 facing the first rotation direction L1, and a second side surface 37 facing the second rotation direction L2 (not illustrated in FIG. 9).

As illustrated in FIG. 7, the protrusions 40 are arrayed in the circumferential direction at intervals. The protrusions 40 include a plurality of column portions 41. The column portions 41 are arranged at equal intervals in the circumferential direction. A portion between the two column portions 41 adjacent to each other in the circumferential direction is a window portion 5 penetrating in the radial direction. The rollers 1 and the cams 2 are arranged on the outer side in the radial direction of the window portions 5 (see FIG. 1). A size of the window portion 5 (interval between the column portions 41 in the circumferential direction) is smaller than the diameters of the rollers 1 and the cams 2. Thus, the rollers 1 and the cams 2 do not pass through the window portions 5 or fall inward in the radial direction.

As illustrated in FIG. 10, an end portion 41a in the first direction X1 of each of the column portions 41 is connected to the second side surface 31b of the first side plate 31. That is, the first direction X1 of the window portion 5 is closed by the first side plate 31. Thus, the rollers 1 and the cams 2 do not move or fall off in the first direction X1 from the window portions 5. On the other hand, an end portion 41b in the second direction X2 of the column portion 41 is not connected to anything. That is, nothing is arranged in the second direction X2 of the window portion 5, and there is an opening portion 6.

As illustrated in FIG. 2, a length in the axial direction of the column portion 41 is smaller than lengths in the axial direction of the rollers 1 and the cams 2. Thus, a part of each roller 1 and a part of each cam 2 are arranged in the second direction X2 from the opening portion 6. That is, the part of each roller 1 and the part of each cam 2 are arranged in the second direction X2 with respect to the end portion 41b in the second direction X2 of the column portion 41.

As illustrated in FIG. 7, some of the column portions 41 have hook portions 7 protruding outward in the radial direction. Hereinafter, among the column portions 41, the column portion 41 not having the hook portion 7 formed is referred to as a first column portion 43, and the column portion having the hook portion 7 formed is referred to as a second column portion 44.

Four second column portions 44 are provided, and the number thereof is the same as that of the cutaways 34. The second column portions 44 are arranged at intervals of 90°. Alternatively, positions in the circumferential direction of the second column portions 44 are arranged in such a manner as to overlap with the cutaways 34. Then, three first column portions 43 are arranged in each portion between the second column portions 44.

As illustrated in FIGS. 8 and 9, each of the second column portions 44 has an outer surface 45 facing outward in the radial direction. The outer surface 45 is arranged on the outer side in the radial direction with respect to surfaces 43a on the outer side in the radial direction of the first column portions 43 (see FIG. 7). Then, the spring 4 is provided across the outer peripheral side of the outer surface 45 (see FIG. 2). In the first embodiment, the second column portion 44 corresponds to a "spring protrusion".

As illustrated in FIG. 9, the bottom surface 35 of the cutaway 34 is arranged in the first direction X1 of the outer surface 45 of the second column portion 44. The outer surface 45 of the second column portion 44 and the bottom surface 35 are formed to be flush with each other. That is, there is no step between the outer surface 45 and the bottom surface 35, and the outer surface 45 and the bottom surface 35 are continuous in the axial direction.

The hook portion 7 is arranged at the end portion 41b in the second direction X2 of the second column portion 44. An outer surface 70 of the hook portion 7 that faces outward in the radial direction has a same diameter as the outer peripheral surface 33 of the first side plate 31. Thus, the hook portion 7 is not in contact with the inner peripheral surface 111 of the outer ring 110.

In addition, the hook portion 7 has a restriction surface 71 facing the first direction X1. The restriction surface 71 is arranged in the second direction X2 with respect to the first groove portions 11 of the rollers 1 and the second groove portions 26 of the cams 2 (see FIG. 2). As illustrated in FIG. 8, a thickness H1 of the hook portion 7 is smaller than a width H2 of the cutaway 34.

A garter spring is used as the spring 4. As illustrated in FIG. 2, the spring 4 is provided across the outer peripheral side of each of the rollers 1, the outer peripheral side of each of the cams 2, and the outer peripheral side of the second column portion 44. In addition, the spring 4 is provided across the outer peripheral side of each of the cams 2 and the outer peripheral side of the second column portion 44 in a state of being enlarged in diameter from a state of being a natural length. That is, the spring 4 biases each of the cams 2 in such a manner as to press the cams 2 inward in the radial direction.

As illustrated in FIG. 2, a portion of the spring 4 that is provided across the second column portion 44 is arranged in the first direction X1 with respect to the hook portion 7. Thus, when a load in the second direction X2 acts on the spring 4, the spring 4 is caught by the restriction surface 71 of the hook portion 7, and a movement thereof is restricted. Thus, the spring 4 does not fall off from the second column portion 44 (retainer body 30).

As illustrated in FIG. 2, the spring 4 is housed in the first groove portions 11 of the rollers 1 and the second groove portions 26 of the cams 2. Thus, when the load in the second direction X2 acts on the rollers 1, the spring 4 is caught on the inner surfaces of the first groove portions 11. Thus, the movement of the rollers 1 in the second direction X2 is restricted. Similarly, when the load in the second direction X2 acts on the cams 2, the spring 4 is caught on the inner surfaces of the second groove portions 26. Thus, the movement of the cams 2 in the second direction X2 is restricted. As described above, although the window portion 5 of the present embodiment has the opening portion 6 that is open in the second direction X2, the falling off of the rollers 1 and the cams 2 is inhibited.

Next, a method of manufacturing the retainer body 30 will be described. The retainer body 30 is manufactured by resin injection molding. In the resin injection molding, a die 200 that is movable in the axial direction is used. The die 200 includes a first die 201 (see FIGS. 8 and 9) arranged in the first direction X1 with respect to a cavity (retainer body 30), and a second die 202 (see FIG. 10) arranged in the second direction X2 with respect to the cavity (retainer body 30).

As illustrated in FIGS. 8 and 9, the first die 201 molds the first side surface 31a of the first side plate. In addition, the first die 201 molds the inner surface (bottom surface 35, first side surface 36, and second side surface 37) of the cutaway 34, the outer surface 45 of the second column portion 44, and the outer surface 70 and the restriction surface 71 of the hook portion 7. After resin in the cavity is cured, the first die 201 moves in the first direction X1. That is, a part of the first die 201 passes through the cutaway 34 and moves in the first direction X1.

In addition, as illustrated in FIG. 10, a part of the second die 202 molds the second side surface 31b of the first side plate 31, and side surfaces in the circumferential direction of the protrusions 40 (first column portion 43 and second column portion 44). After the resin in the cavity is cured, a part of the second die 202 passes through the opening portion 6 and moves in the second direction X2. From the above, the retainer body 30 is manufactured by the die 200 movable in the axial direction.

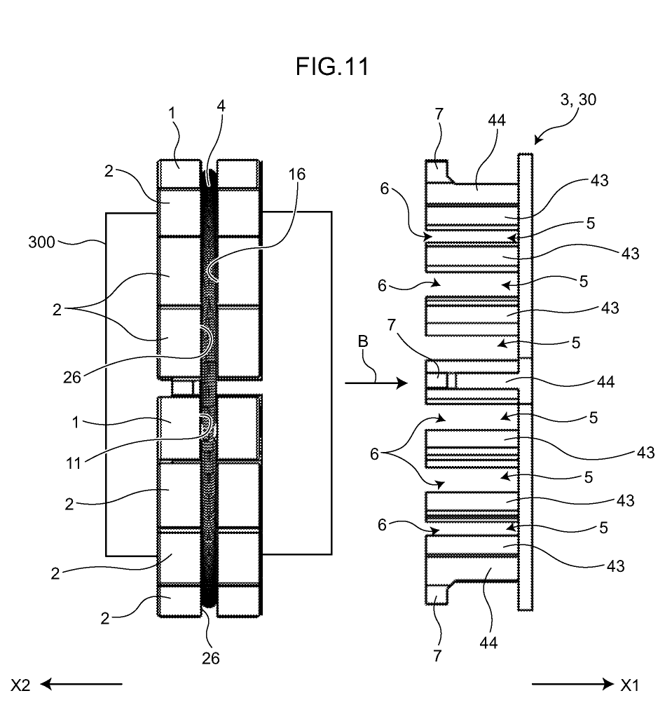

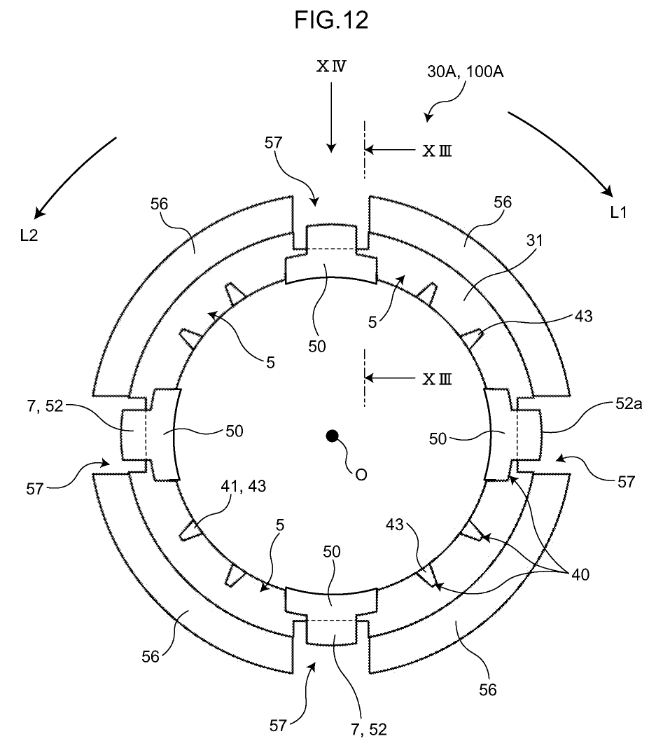

FIG. 11 is a view illustrating an assembly process of the one-way clutch of the first embodiment. Next, a method of assembling the one-way clutch 100 will be described. As illustrated in FIG. 11, a jig 300 is used in the assembly process of the one-way clutch 100. The jig 300 is a columnar component. A diameter of the jig 300 is smaller than an inner diameter of the retainer body 30. That is, the jig 300 can be inserted into the inner peripheral side of the column portions 41.

The spring 4 is hooked on an outer peripheral surface of the jig 300. Then, the rollers 1 and the cams 2 are arranged between the jig 300 and the spring 4. In addition, the spring 4 is arranged in such a manner as to be housed in the first groove portions 16 of the rollers 1 and the second groove portions 26 of the cams 2. According to the above, as illustrated in FIG. 11, the rollers 1 and the cams 2 are arranged in the circumferential direction on the outer peripheral surface of the jig 300. In addition, the spring 4 is provided across the outer peripheral side of the rollers 1 and the cams 2. A groove that positions the rollers 1 and the cams 2 such that the rollers 1 and the cams 2 do not move in the circumferential direction may be formed in the outer peripheral surface of the jig 300 in the present disclosure.

Then, the jig 300 is inserted into the inner peripheral side of the retainer body 30 from the second direction X2 of the retainer body 30 (see an arrow B in FIG. 11). According to the above, the rollers 1 and the cams 2 pass through the opening portions 6 and are arranged on the outer side in the radial direction of the window portions 5. In addition, when the jig 300 is inserted, the spring 4 is deformed outward in the radial direction so as to pass over the hook portion 7 on which the spring 4 would otherwise be caught. Then, the spring 4 is hooked on the outer peripheral side of the second column portions 44. Finally, the jig 300 is moved in the axial direction, and the rollers 1, the cams 2, and the spring 4 are separated from the jig 300. As a result, the one-way clutch 100 is completed.

As described above, according to the first embodiment, in the assembly of the one-way clutch 100, the rollers 1, the cams 2, and the spring 4 can be assembled together to the retainer body 30. Thus, it is not necessary to arrange and fix the cams 2 and the like one by one in the window portions 5, and productivity is improved. In addition, the die 200 that manufactures the retainer body 30 includes the first die 201 and the second die 202 that are movable in the axial direction. Thus, the die 200 can be simplified.

The first groove portions 11 of the rollers 1 and the second groove portions 26 of the cams 2 are provided at the central portion in the axial direction. When the first groove portion 11 is provided at the end portion in the second direction X2 of each of the rollers 1, the central axis O1 of the roller 1 is inclined. As a result, a surface pressure of a part of the roller 1 increases, and a life of the roller 1 is shortened. Also in each of the cams 2, when the second groove portion 26 is provided at the end portion in the second direction X2 of the cam 2, the central axis O2 of the cam 2 is inclined, and a life of the cam 2 is shortened. Thus, according to the first embodiment, the rollers 1 and the cams 2 are not inclined, whereby the rollers 1 and the cams 2 can be used for a long period of time.

Although the first embodiment has been described above, the present disclosure is not limited to the example described in the first embodiment. For example, although the torque is input to the outer ring 110 out of the outer ring 110 and the inner ring 120 in the first embodiment, the torque may be input to the inner ring 120 in the present disclosure. The number and arrangement of the rollers 1 and the cams 2 are not limited to the number and arrangement described as the example in the first embodiment.

Although the first groove portions 11 of the first embodiment are arranged at the central portion in the axial direction of the rollers 1, an arrangement at a portion other than the central portion in the axial direction of the rollers 1 is possible in the present disclosure. That is, the first groove portions 11 may be arranged at the end portions in the first direction X1 or the end portions in the second direction X2 of the rollers 1. Similarly, the second groove portions 26 of the present disclosure may be arranged at the end portions in the first direction X1 or the end portions in the second direction X2 of the cams 2.

Although the hook portion 7 of the first embodiment is arranged at the end portion in the second direction X2 of the spring protrusion (second column portion 44), an arrangement at a portion other than the end portion in the second direction X2 of the spring protrusion is possible in the present disclosure. When the hook portion 7 is arranged in the second direction X2 with respect to the spring 4 provided across the spring protrusion, it is possible to prevent the spring 4 from falling off. Thus, as long as the hook portion 7 is arranged in the second direction X2 with respect to the spring 4, a position in the axial direction where the hook portion is formed in the spring protrusion is not specifically limited.

In addition, although the protrusions 40 of the first embodiment are composed of the column portions 41 (first column portion 43 and second column portion 44), protrusions may include bearing portions in the present disclosure. In the following first modification, a retainer body 30 having bearing portions will be described. Only differences from the first embodiment will be described in the following description.

### First Modification

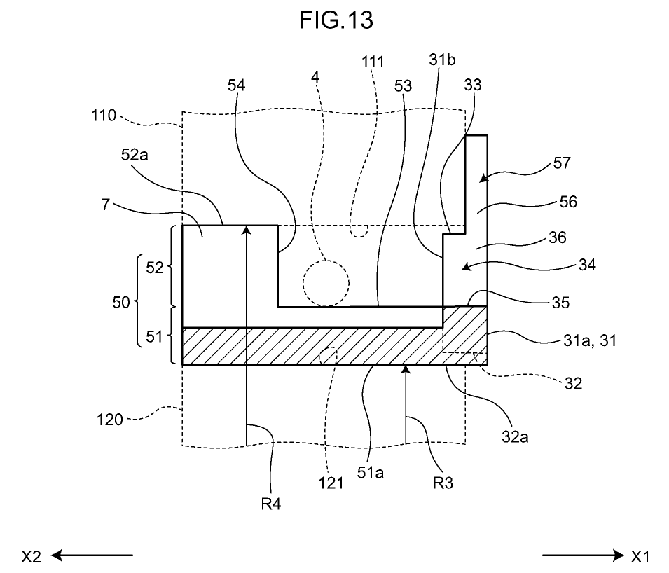

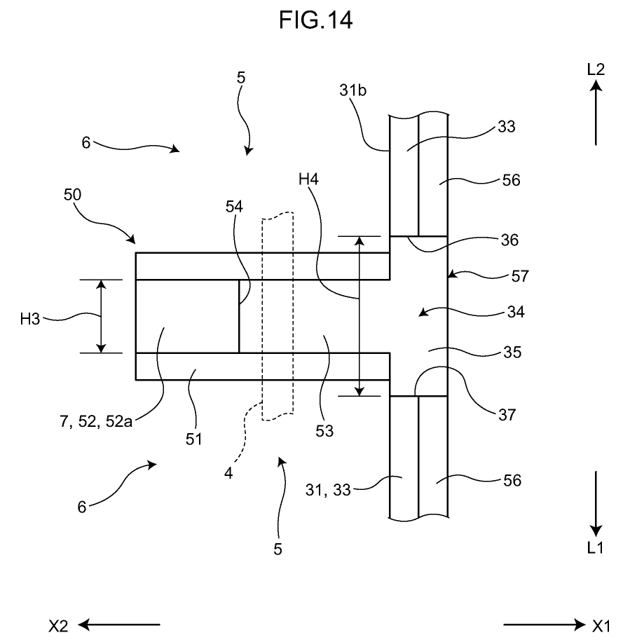

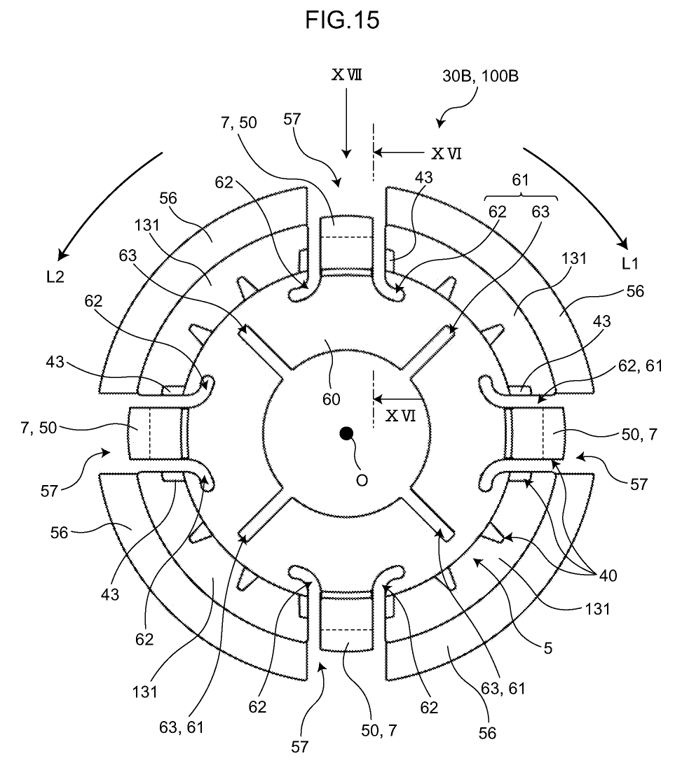

FIG. 12 is a view of a retainer (retainer body) of the first modification as viewed from the second direction. FIG. 13 is a sectional view taken along a line XIII-XIII in FIG. 12. FIG. 14 is a view as viewed in a direction of an arrow XIV in FIG. 12.

As illustrated in FIG. 12, a retainer body 30A of the first modification is different from the retainer body 30 of the first embodiment in that bearing portions 50 are included instead of the second column portions 44 (see FIG. 7). That is, the protrusions 40 of the first embodiment are composed of the first column portions 43 and the second column portions 44, whereas the protrusions 40 of the first modification are composed of the first column portions 43 and the bearing portions 50. In addition, a retainer body 30A is different from the retainer body 30 of the first embodiment in that an outer flange 56 protruding outward in the radial direction is included.

As illustrated in FIG. 13, each of the bearing portions 50 includes an inner ring receiving portion 51, and an outer ring receiving portion 52 protruding outward in the radial direction from the inner ring receiving portion 51. The inner ring receiving portion 51 protrudes in the second direction X2 from the second side surface 31b of the first side plate 31. An inner diameter R3 of the inner ring receiving portion 51 is the same as a diameter of an outer peripheral surface 121 of the inner ring 120. An inner surface 51a of the inner ring receiving portion 51 abuts on the outer peripheral surface 121 of the inner ring 120.

A portion 32a of the inner peripheral surface 32 of the first side plate 31 that is arranged in the first direction X1 of the inner ring receiving portion 51 has the same diameter as the inner surface 51a. Thus, the portion 32a of the first side plate 31 protrudes inward in the radial direction with respect to the inner peripheral surface 32 of the first side plate 31, and abuts on the outer peripheral surface 121 of the inner ring 120.

An outer diameter R4 of the outer ring receiving portion 52 is the same as a diameter of the inner peripheral surface 111 of the outer ring 110. An outer peripheral surface 52a of the outer ring receiving portion 52 abuts on the inner peripheral surface 111 of the outer ring 110. As illustrated in FIG. 12, the four bearing portions 50 are provided. The four bearing portions 50 are arranged at intervals of 90°.

From the above, a distance between the inner peripheral surface 111 and the outer peripheral surface 121 is R1 (see FIG. 1) at any position in the circumferential direction, and the outer ring 110 and the inner ring 120 are coaxially arranged. In addition, since the bearing portions 50 are included, the roller 1 is unnecessary in the first modification. That is, a one-way clutch 100A of the first modification does not include the roller 1.

Although the inner diameter R3 of the inner ring receiving portion 51 of the present embodiment is the same as the diameter of the outer peripheral surface 121 of the inner ring 120, the inner diameter R3 of the inner ring receiving portion 51 may be larger than the diameter of the outer peripheral surface 121 of the inner ring 120 in the present disclosure. Although the outer diameter R4 of the outer ring receiving portion 52 of the present embodiment is the same as the diameter of the inner peripheral surface 111 of the outer ring 110, the outer diameter R4 of the outer ring receiving portion 52 may be smaller than the diameter of the inner peripheral surface 111 of the outer ring 110 in the present disclosure.

As illustrated in FIG. 13, the inner ring receiving portion 51 has an outer surface 53 facing outward in the radial direction. The spring 4 is provided across the outer peripheral side of the inner ring receiving portion 51. Thus, the bearing portions 50 constitute "spring protrusions" in the first modification. The bottom surface 35 of the cutaway 34 is arranged in the first direction X1 of the outer surface 53. There is no step between the outer surface 53 and the bottom surface 35, and the outer surface 53 and the bottom surface 35 are continuous in the axial direction.

The outer ring receiving portion 52 is arranged at an end portion in the second direction X2 of the inner ring receiving portion 51. The outer ring receiving portion 52 has a restriction surface 54 facing the first direction X1. The restriction surface 54 is arranged in the second direction X2 with respect to the spring 4. When a load in the second direction X2 acts on the spring 4, the spring 4 is caught by the restriction surface 54. Thus, the spring 4 is prevented from falling off from a retainer 3. That is, in the first modification, the outer ring receiving portion 52 constitutes the hook portion 7 of the first embodiment.

As illustrated in FIG. 12, the window portions 5 are provided on both sides in the circumferential direction of the bearing portions 50. Thus, the bearing portions 50 of the first modification serve as a frame portion surrounding the window portions 5. As illustrated in FIG. 14, nothing is connected to an end portion in the second direction X2 of each of the bearing portions 50. Thus, the window portions 5 arranged on both sides in the circumferential direction of the bearing portion 50 are open in the second direction X2 by the opening portions 6. From the above, also in the first modification, the second side surface 31b of the first side plate 31 and a side surface in the circumferential direction of the bearing portion 50 can be formed by a second die 202 movable in the axial direction (see FIG. 10).

A width H3 of the outer ring receiving portion 52 (hook portion 7) is smaller than a width H4 of the cutaway 34. Thus, the inner surface (bottom surface 35, first side surface 36, and second side surface 37) of the cutaway 34, the outer surface 53, the restriction surface 54, and the outer peripheral surface 52a can be molded by the first die 201 movable in the axial direction (see FIGS. 8 and 9).

As illustrated in FIG. 13, the outer flange 56 is provided on an outer peripheral surface 33 of the first side plate 31. The outer flange 56 abuts on the outer ring 110 in the first direction X1. Thus, the one-way clutch 100A is restricted from moving in the second direction X2.

As illustrated in FIG. 14, flange cutaways 57 having the same size as the width H4 of the cutaway 34 are formed in the outer flange 56. As illustrated in FIG. 12, the four flange cutaways 57 are provided. Thus, the outer flange 56 is divided into four in the circumferential direction. In addition, the first die 201 (see FIGS. 8 and 9) can pass through the flange cutaways 57 after molding the outer surface 53, the restriction surface 54, and the outer peripheral surface 52a.

The first modification has been described above. Next, the second modification in which an inner flange is provided in the retainer body 30A of the first modification will be described.

### Second Modification

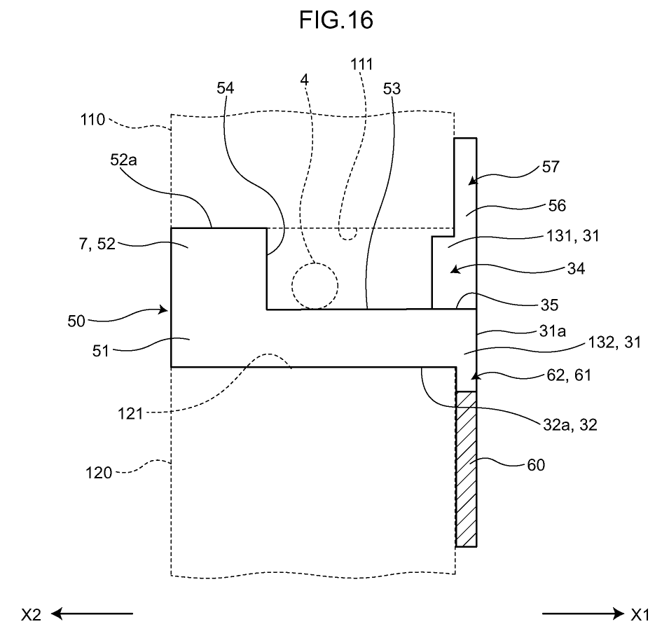

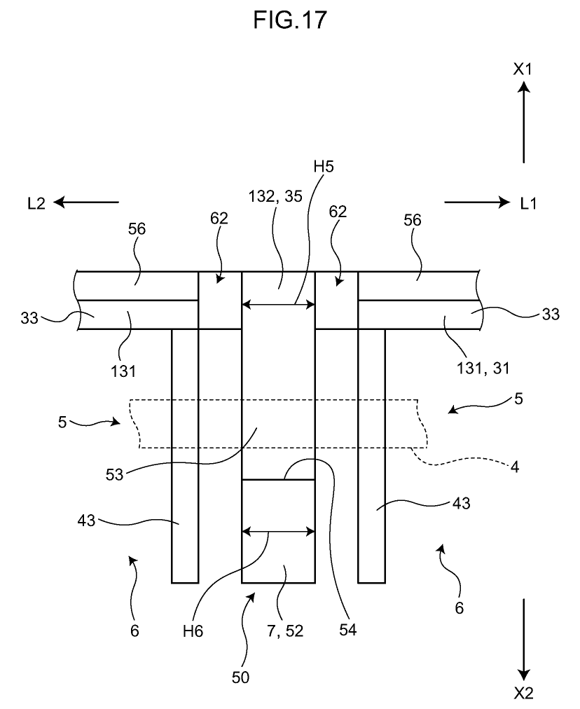

FIG. 15 is a view of a retainer body of the second modification as viewed from the second direction. FIG. 16 is a sectional view taken along a line XVI-XVI in FIG. 15. FIG. 17 is a view as viewed in a direction of an arrow XVII in FIG. 15. As illustrated in FIG. 15, a retainer body 30B of the second modification is different from the retainer body 30A of the first modification in that an inner flange 60 is included. In addition, the retainer body 30B is different from the retainer body 30 of the first modification in that a plurality of deformation cutaways 61 extending in the radial direction are included. As illustrated in FIGS. 15 and 17, the retainer body 30B of the second modification is different from the retainer body 30A of the first modification in that the first column portions 43 are added to both sides of each of the bearing portions 50.

As illustrated in FIG. 16, the inner flange 60 is provided on an inner peripheral surface 32 of the first side plate 31. The inner flange 60 abuts on an inner ring 120 in the first direction X1. Thus, a one-way clutch 100B is restricted from moving in the second direction X2.

As illustrated in FIG. 15, the deformation cutaway 61 includes a first cutaway 62 in which the first side plate 31 is cut away, and a second cutaway 63 in which the inner flange 60 is cut away.

As illustrated in FIG. 17, the first cutaways 62 extend inward in the radial direction from both side portions in the circumferential direction of the bottom surface 35 of the first side plate 31. Thus, in the second modification, a width H5 in the circumferential direction of the bottom surface 35 is the same as a width H6 of the outer ring receiving portion 52 (hook portion 7).

As illustrated in FIG. 15, the first cutaways 62 extend to the outer side in the radial direction of the inner flange 60, and the first side plate 31 is divided in the circumferential direction. Thus, the first side plate 31 of the second modification is divided into four long side plates 131 that are long in the circumferential direction (see FIG. 15) and four short side plates 132 that are short in the circumferential direction (see FIG. 17).

As illustrated in FIG. 15, four first column portions 43 are connected to the long side plate 131. In addition, the outer flange 56 is provided in the long side plate 131. As illustrated in FIGS. 16 and 17, the bearing portion 50 is connected to the short side plate 132. Then, the long side plates 131 and the short side plates 132 are connected via the inner flange 60. As illustrated in FIG. 15, the second cutaways 63 each extend outward in the radial direction from an end portion on an inner side in the radial direction of the inner flange 60. In addition, the second cutaways 63 each extend to a portion near an end portion on the outer side in the radial direction of the inner flange 60.

As described above, according to the second modification, when the one-way clutch 100B is assembled between an outer ring 110 and an inner ring 120, the retainer body 30B is easily deformed. Thus, assemblability in assembling the one-way clutch 100B to the outer ring 110 or the like is improved.

The second modification has been described above. Although the deformation cutaways 61 of the second modification include the first cutaways 62 and the second cutaways 63, either the first cutaways 62 or the second cutaways 63 may be included, but not both, and the example described in the second modification is not a limitation in the present disclosure.

In addition, although the retainer 3 includes only the retainer body 30, 30A, or 30B in the first embodiment or the like described above, the retainer 3 of the present disclosure may have other components in addition to the retainer body. Hereinafter, a third modification and a fourth modification in which a retainer includes a retainer body and other components will be described.

### Third Modification

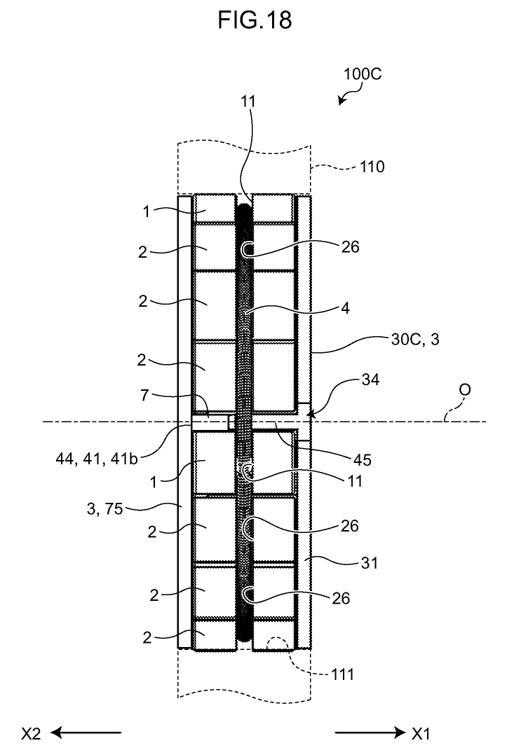

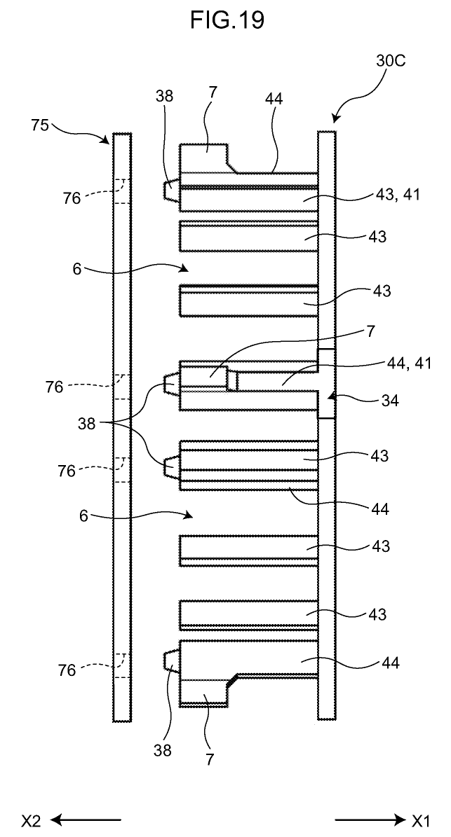

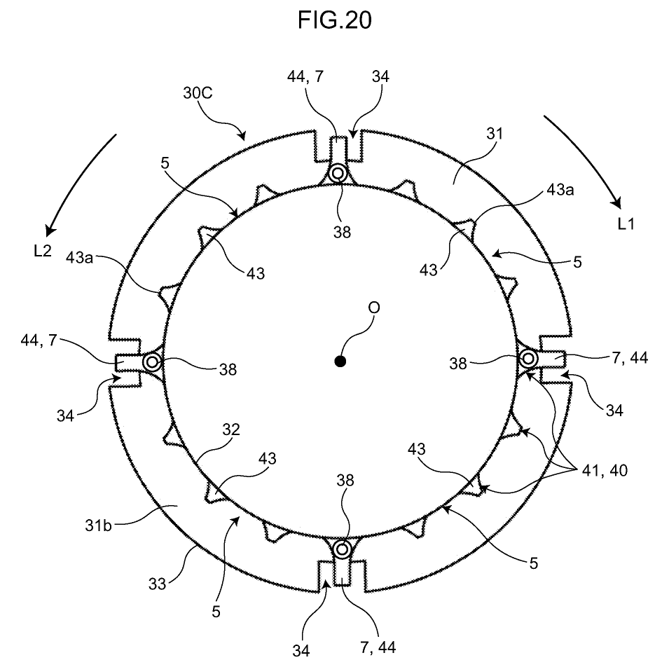

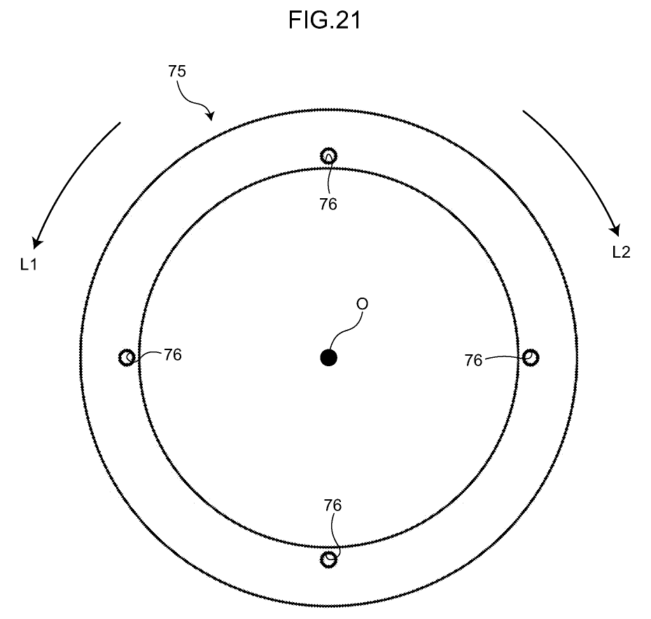

FIG. 18 is a view of a one-way clutch of the third modification as viewed from an outer peripheral side. FIG. 19 is a view of a state in which a retainer of the third modification is disassembled as viewed from the outer peripheral side. FIG. 20 is a view of a retainer body of the third modification as viewed from the second direction. FIG. 21 is a view of a second side plate of the third modification as viewed from the first direction. As illustrated in FIGS. 18 and 19, a one-way clutch 100C of the third modification is different from that of the first embodiment in that a retainer 3 includes a retainer body 30C and a second side plate 75.

As illustrated in FIGS. 19 and 20, protrusions 40 of the retainer body 30C are to the same as those of the first embodiment in that column portions 41 (first column portion 43 and second column portion 44) are included. However, there is a difference from the first embodiment in that a length in the axial direction of the column portions 41 (first column portion 43 and second column portion 44) of the third modification is larger than lengths in the axial direction of rollers 1 and cams 2. As illustrated in FIG. 18, end portions 41b in the second direction X2 of the column portions 41 are arranged in the second direction X2 with respect to the rollers 1 and the cams 2. The end portions 41b in the second direction X2 of the column portions 41 are welded to the second side plate 75, and the retainer body 30C and the second side plate 75 are integrated.

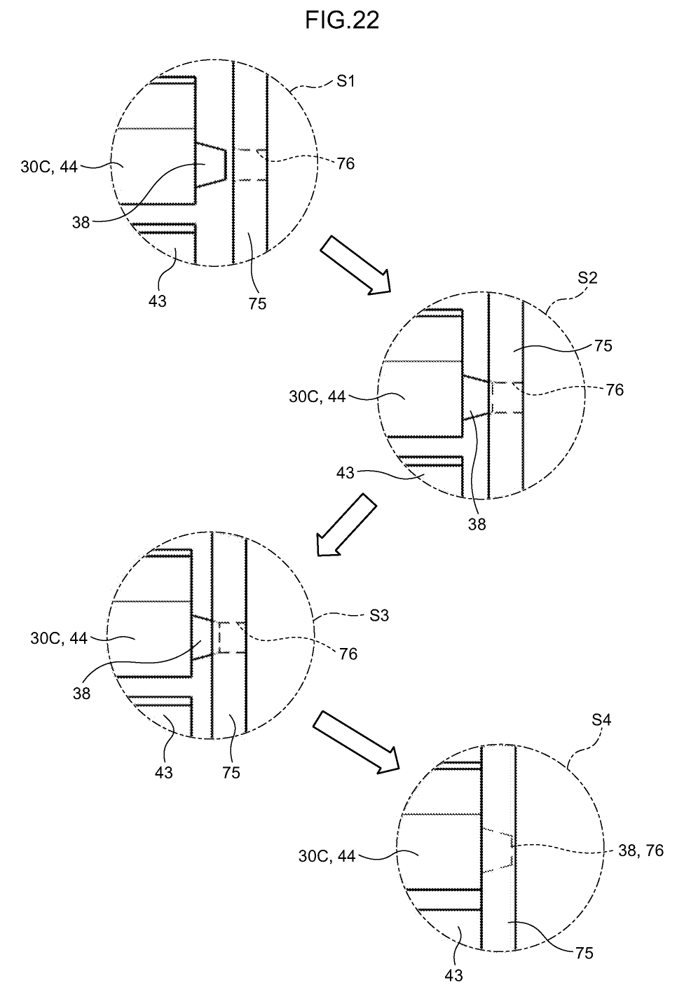

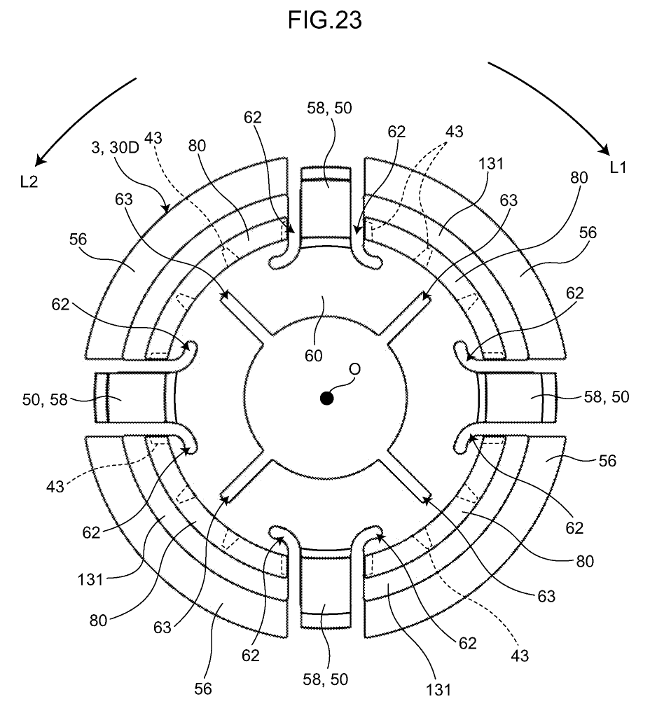

As illustrated in FIGS. 19 and 20, protrusions 38 protruding in the second direction X2 are formed on end surfaces in the second direction X2 of the column portions 41. The protrusions 38 are provided on end surfaces in the second direction X2 of the second column portions 44 (see FIG. 20). Thus, the protrusions 38 are arranged at intervals of 90°, and the four protrusions 38 are provided in total. The protrusions 38 have a truncated cone shape (see FIG. 22).

The second side plate 75 is made of a resin material. As illustrated in FIG. 21, the second side plate 75 is formed in an annular shape. An inner diameter and an outer diameter of the second side plate 75 are the same as an inner diameter and an outer diameter of the first side plate 31. Through holes 76 penetrating in the axial direction are formed in the second side plate 75. The through holes 76 are arranged at intervals of 90°, and the four through holes 76 are provided in total. Next, a method of welding the retainer body 30C and the second side plate 75 will be described.

FIG. 22 is a view illustrating a method of welding the retainer body and the second side plate in the third modification. As illustrated in FIG. 22, in a first step S1 of the welding method, the protrusions 38 of the retainer body 30C and the through holes 76 of the second side plate 75 are made to face each other in the axial direction. Then, in a second step S2, tip portions of the protrusions 38 are inserted into the through holes 76. Thus, the retainer body 30C is positioned with respect to the second side plate 75.

In a third step S3, the protrusions 38 arranged in the through holes 76 in the second direction X2 of the second side plate 75 or the retainer body 30C is vibrated by ultrasonic waves, and contact portions between the protrusions 38 and the through holes 76 are melted. In a fourth step S4, the second side plate 75 is pressed toward the retainer body 30C. With this process, the melted protrusions 38 are pushed out toward the depths of the through holes 76, and the through holes 76 are filled with the melted protrusions 38. Then, the protrusions 38 are left to be cured, whereby a retainer 3 is completed.

When the second side plate 75 is welded to the retainer body 30C, a side in the second direction X2 of the window portion 5 is closed by the second side plate 75. Thus, it is necessary to assemble the rollers 1, the cams 2, and the spring 4 to the retainer body 30C by using the jig 300 before welding the retainer body 30C and the second side plate 75.

As described above, according to the one-way clutch 100C of the third modification, an opening portion 6 is closed by the second side plate 75. Thus, the rollers 1 and the cams 2 do not fall off from the retainer 3.

### Fourth Modification

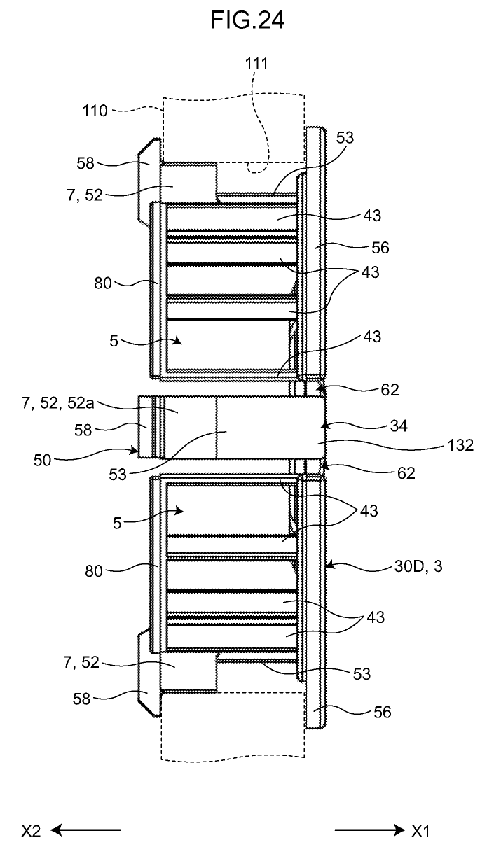

FIG. 23 is a view of a retainer of the fourth modification as viewed from the second direction. FIG. 24 is a view of the retainer of the fourth modification as viewed from the outer peripheral side. As illustrated in FIGS. 23 and 24, the retainer 3 of the fourth modification is different from that of the first embodiment in that a retainer body 30D and second side plates 80 are included.

A retainer body 30D includes the first column portions 43, the bearing portions 50, the outer flange 56, the inner flange 60, and the deformation cutaways 61 as in the retainer body 30B of the second modification. However, the fourth modification is different from the second modification in that a length in the axial direction of protrusions 40 (first column portion 43 and bearing portion 50) is larger than lengths in the axial direction of rollers 1 and cams 2.

As illustrated in FIG. 23, the second side plates 80 are formed in an arc shape as viewed in the axial direction. The four second side plates 80 are provided. The second side plates 80 are arranged in the second direction X2 with respect to the long side plates 131 of the first side plate 31. The second side plates 80 are welded to end portions in the second direction of the four first column portions 43. As a result, the retainer body 30D and the second side plates 80 are integrated.

Also in the fourth modification, when the second side plates 80 are welded to the retainer body 30D, a side in the second direction X2 of the window portion 5 is closed by the second side plates 80. Thus, it is necessary to assemble the rollers 1, the cams 2, and the spring 4 to the retainer body 30D by using the jig 300 before welding the retainer body 30D and the second side plates 80.

As illustrated in FIG. 24, there is a difference from the second modification in that a second outer flange 58 is formed on end surfaces in the second direction X2 of the bearing portions 50. The second outer flange 58 protrudes outward in the radial direction with respect to an outer peripheral surface 52a of the outer ring receiving portion 52. The second outer flange 58 abuts on the outer ring 110 in the second direction X2. That is, the outer ring 110 is sandwiched between the outer flange 56 and the second outer flange 58. Thus, the retainer 3 does not move in the axial direction with respect to the outer ring.

The third modification and the fourth modification have been described above. Although the retainer bodies 30C and 30D and the second side plates 75 and 80 are bonded by welding in the third modification and the fourth modification, but a method of bonding the retainer bodies 30C and 30D and the second side plates 75 and 80 is not limited in the present disclosure, and an adhesive may be used, for example. Furthermore, although the second side plates 75 and 80 made of resin are combined with the retainer bodies 30C and 30D made of resin in the third modification and the fourth modification, end bearings made of metal may be combined. In this case, the retainer body and the end bearings are integrated by fitting or installing the end bearings on the outer peripheral side of the first column portions 43 and the like.

Although the second outer flange 58 is provided in the bearing portions 50 of the fourth modification, the second outer flange 58 may be provided in the bearing portions 50 of the first modification or the second modification in the present disclosure.

Note that the present disclosure may include combinations of the following configurations.

(1) A one-way clutch comprising:

a plurality of cams arranged between an outer ring and an inner ring and arrayed in a circumferential direction;

a retainer that holds the cams; and

an annular spring provided across an outer peripheral side of the cams, wherein

each of the cams comprises

an outer surface facing an outer side in a radial direction and facing the outer ring, and

a groove portion in which the outer surface is cut away in the circumferential direction and the spring is housed, and

an axial direction is defined as a direction parallel to a central axis of the outer ring,

the retainer comprises a retainer body made of resin,

the retainer body comprises

an annular first side plate arranged on one side in the axial direction with respect to the cams, and

a plurality of protrusions protruding from the first side plate to the other side in the axial direction and arrayed in the circumferential direction,

the protrusions comprise

a plurality of column portions, and

at least one spring protrusion with the spring provided across the outer peripheral side,

a window portion with the cam arranged is formed between two of the column portions adjacent to each other in the circumferential direction,

one side in the axial direction of the window portion is closed by the first side plate, and the other side in the axial direction thereof is open,

a hook portion protruding outward in the radial direction and arranged on the other side in the axial direction with respect to the spring is formed on the at least one spring protrusion, and

the first side plate is provided with a cutaway formed by cutting away a portion facing the hook portion in the axial direction.

(2) The one-way clutch according to (1), wherein

the groove portion is arranged in a central portion in the axial direction of the outer surface.

(3) The one-way clutch according to (1) or (2), wherein

the at least one spring protrusion forms at least one of the column portions, and

the window portion is formed between the spring protrusion and another of the column portions.

(4) The one-way clutch according to (3), further comprising

a plurality of rollers arranged between the outer ring and the inner ring and abutting on an inner peripheral surface of the outer ring and an outer peripheral surface of the inner ring, wherein

the rollers are each arranged at the window portion and held by the retainer body.

(5) The one-way clutch according to (1) or (2), wherein

the spring protrusion is an inner ring receiving portion that protrudes from the first side plate to the other side in the axial direction and abuts on an outer peripheral surface of the inner ring,

an outer ring receiving portion that protrudes outward in the radial direction and abuts on an inner peripheral surface of the outer ring is formed at the inner ring receiving portion, and

the outer ring receiving portion forms the hook portion.

(6) The one-way clutch according to (1) or (2), wherein

a length in the axial direction of the protrusions is smaller than a length in the axial direction of the cams.

(7) The one-way clutch according to (1) or (2), wherein

the retainer comprises a second side plate made of resin and formed in an annular shape,

a length in the axial direction of the protrusions is larger than a length in the axial direction of the cams, and

the second side plate is arranged on the other side in the axial direction with respect to the cams and is bonded to end portions on the other side in the axial direction of the protrusions.

In the retainer body of the present disclosure, the other side in an axial direction of the window portion is open. Thus, the plurality of cams arrayed in a circumferential direction and the spring provided across the outer peripheral side of the cams can be collectively assembled to the retainer body from the other side in the axial direction. Thus, the need to arrange and fix the cams one by one in the window portion is eliminated, and productivity is improved. Furthermore, the spring is restricted from moving to the other side in the axial direction by the hook portion. In a case where a load to the other side in the axial direction acts on the cams, the spring is caught on an inner surface of the groove portion, and the cams are prevented from falling off. Furthermore, the other side in the axial direction of the window portion is open. One side in the axial direction of the hook portion is provided with a cutaway and is open. Thus, the retainer body of the present disclosure can be manufactured with a die that operates in the axial direction, and the die can be simplified.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A one-way clutch comprising:
a plurality of cams arranged between an outer ring and an inner ring and arrayed in a circumferential direction;
a retainer that holds the cams; and
an annular spring provided across an outer peripheral side of the cams, wherein
each of the cams comprises
an outer surface facing an outer side in a radial direction and facing the outer ring, and
a groove portion in which the outer surface is cut away in the circumferential direction and the spring is housed, and
an axial direction is defined as a direction parallel to a central axis of the outer ring,
the retainer comprises a retainer body made of resin,
the retainer body comprises
an annular first side plate arranged on one side in the axial direction with respect to the cams, and
a plurality of protrusions protruding from the first side plate to the other side in the axial direction and arrayed in the circumferential direction,
the protrusions comprise
a plurality of column portions, and
at least one spring protrusion with the spring provided across the outer peripheral side,
a window portion with the cam arranged is formed between two of the column portions adjacent to each other in the circumferential direction,
one side in the axial direction of the window portion is closed by the first side plate, and the other side in the axial direction thereof is open,
a hook portion protruding outward in the radial direction and arranged on the other side in the axial direction with respect to the spring is formed on the at least one spring protrusion, and
the first side plate is provided with a cutaway formed by cutting away a portion facing the hook portion in the axial direction.

2. The one-way clutch according to claim 1, wherein
the groove portion is arranged in a central portion in the axial direction of the outer surface.

3. The one-way clutch according to claim 1, wherein
the at least one spring protrusion forms at least one of the column portions, and
the window portion is formed between the spring protrusion and another of the column portions.

4. The one-way clutch according to claim 2, wherein
the at least one spring protrusion forms at least one of the column portions, and
the window portion is formed between the spring protrusion and another of the column portions.

5. The one-way clutch according to claim 3, further comprising
a plurality of rollers arranged between the outer ring and the inner ring and abutting on an inner peripheral surface of the outer ring and an outer peripheral surface of the inner ring, wherein
the rollers are each arranged at the window portion and held by the retainer body.

6. The one-way clutch according to claim 4, further comprising
a plurality of rollers arranged between the outer ring and the inner ring and abutting on an inner peripheral surface of the outer ring and an outer peripheral surface of the inner ring, wherein
the rollers are each arranged at the window portion and held by the retainer body.

7. The one-way clutch according to claim 1, wherein
the spring protrusion is an inner ring receiving portion that protrudes from the first side plate to the other side in the axial direction and abuts on an outer peripheral surface of the inner ring,
an outer ring receiving portion that protrudes outward in the radial direction and abuts on an inner peripheral surface of the outer ring is formed at the inner ring receiving portion, and
the outer ring receiving portion forms the hook portion.

8. The one-way clutch according to claim 2, wherein
the spring protrusion is an inner ring receiving portion that protrudes from the first side plate to the other side in the axial direction and abuts on an outer peripheral surface of the inner ring,
an outer ring receiving portion that protrudes outward in the radial direction and abuts on an inner peripheral surface of the outer ring is formed at the inner ring receiving portion, and
the outer ring receiving portion forms the hook portion.

9. The one-way clutch according to claim 1, wherein
a length in the axial direction of the protrusions is smaller than a length in the axial direction of the cams.

10. The one-way clutch according to claim 2, wherein
a length in the axial direction of the protrusions is smaller than a length in the axial direction of the cams.

11. The one-way clutch according to claim 1, wherein
the retainer comprises a second side plate made of resin and formed in an annular shape,
a length in the axial direction of the protrusions is larger than a length in the axial direction of the cams, and
the second side plate is arranged on the other side in the axial direction with respect to the cams and is bonded to end portions on the other side in the axial direction of the protrusions.

12. The one-way clutch according to claim 2, wherein
the retainer comprises a second side plate made of resin and formed in an annular shape,
a length in the axial direction of the protrusions is larger than a length in the axial direction of the cams, and
the second side plate is arranged on the other side in the axial direction with respect to the cams and is bonded to end portions on the other side in the axial direction of the protrusions.
